(19) United States
(12) Patent Application Publication
(10) Pub. No.: US 2011/0042910 A1
(43) Pub. Date: Feb. 24, 2011

(54) COLLAPSIBLE SERVICE TROLLEY

(76) Inventor: Ricardo Ceballos-Godefroy, Col. Del Valle (MX)

Correspondence Address: Browdy and Neimark, PLLC, 1625 K Street, N.W., Suite 1100, Washington, DC, 20006, US

(21) Appl. No.: 12/516,338

(22) PCT Filed: Nov. 21, 2007
(86) PCT No.: PCT/IB07/03578

§ 371 Date: Nov. 8, 2010

(30) Foreign Application Priority Data
Nov. 23, 2006 (MX) PA/A/2006/013580

(51) Int. Cl. B62B 3/02

(52) U.S. Cl. 280/42

(57) ABSTRACT

The invention described is a collapsible service trolley with left and right side compartments; one left front wall is hinged to the left side compartment; one right front wall is hinged to the right side compartment; one left back door is hinged to the left side compartment; one right back door is hinged to the right side compartment; one left upper wall hinged to the left side compartment; one right upper wall hinged to the right side compartment and hinged to the left upper wall; one left lower wall hinged to the left side compartment and one right lower wall hinged to the right side compartment and hinged to the left lower wall. In the collapsed position of the trolley each compartment contains the elements hinged thereto; in said position, the trolley is compact and easily stored.

### FIELD OF THE INVENTION

The present invention relates to the techniques employed in the manufacture and design of displays and trolleys used at sites referred to as “points of sale”, including restaurants, where various products, services and food types are offered to the public; more particularly, to a collapsible service trolley.

### BACKGROUND OF THE INVENTION

In different places where the public converges for the acquisition and promotion of products and services such as exhibitions, conventions, information centers or hotels and restaurants where food and beverages are offered and carried around for tables or rooms, there exists the constant need to use service trolleys maneuvered by one person in order to swiftly carry products and food from one place to another. For instance, there exist trolleys for selling ice creams, hot-dog trolleys, dessert and beverage trolleys for use in a hotel; additionally, at supermarkets, shopping trolleys are used to carry goods and money towards the cashiers. Hence, there exists a myriad of everyday activities where service trolleys are employed.

Services trolleys may include internal compartments, doors, dividing shelves and so on, whereas its manufacturing materials mainly comprise wood and metal. Nevertheless, in general terms, all these trolleys have a rigid structure and are of a bulky nature in order to carry and contain products therein in a safe manner; therefore, their main drawback is that folding or collapsing thereof is not possible when not in use, and thus be stored in a reduced space.

On the other hand, there exist other types of furniture widely employed at points of sale, such as displays and counters, of which collapsible versions are available and very practical and compact sized, such as the displays by the same inventor of the present invention and disclosed in Mexican patents Nos. 212, 227; 225,710 and in the international patent application No. PCT/IB2005/002083. However, these displays are far from meeting the purposes of service trolleys, as none includes wheels or doors to close the module base and create an internal chamber with restricted access.

### SUMMARY OF THE INVENTION

Pursuant to the above, the purpose is to eliminate the drawbacks of service trolleys known to date through the development of a sturdy and usable collapsible service trolley, with an arranged structure of its elements that allow the same to be folded into a very compact shape and stored in reduced spaces. In addition, when the trolley is in its folded position, carrying thereof is simple and swift.

The collapsible service trolley of the present invention comprises one left side housing and one right side housing; both housings essentially shape the sides of the trolley. At the front part of the trolley, there is located one front left wall, which is hingedly attached to the left side housing such that it can be housed therein. In a similar fashion, there exists one front right wall hingedly attached to the right side housing such that it can be housed therein.

At the rear part thereof, the service trolley of the present invention comprises one left rear door hingedly attached to the left side housing and housed therein on top of or underneath said front left wall when the latter is housed inside the left side housing. Likewise, there exists one right rear door hingedly attached to the right side housing and housed therein on top of or underneath said front right wall when the latter is also housed inside the right side housing.

Now, at the upper part of the service trolley of the present invention, it comprises one upper left wall hingedly attached to the left side housing and housed therein on the rear door or the front left wall when the same are housed therein. There also exists one upper right wall hingedly attached to the right side housing and hingedly attached to the upper left wall; the upper right wall is housed within the right side housing on the rear door or the front right wall when the same are housed therein. The upper left and right walls connect said left and right side housings by their upper part.

In addition, there is located one bottom left wall hingedly attached to the left side housing and housed therein on the rear door or the front left wall when the same are housed therein, and one bottom right wall is provided hingedly attached to the right side housing and hingedly attached to the bottom left wall; the bottom right wall is housed in the right side housing on the rear door or the front right wall when the same are housed therein. The bottom right and left walls connect said left and right housings by their bottom.

Finally, at the bottom of the left and right side housings, wheels are mounted thereon to displace the trolley on any surface.

In order to fold down the service trolley from an upright position, the front left wall is housed in the left side housing and the front right wall is housed in the right side housing; the rear left door also moves inwards of the trolley to be housed in the left side housing and the rear right door moves inwards of the trolley to be housed in the right side housing. Afterwards, the left side housing and the right side housing are brought closer to each other until they make contact, such that during this movement the upper left and right walls are folded downwardly at their attachment zone; meanwhile, the bottom left and right walls are folded upwardly on their attachment zone, and therefore said bottom and upper walls are housed in the housing on their respective side, thereby achieving the “collapsed” and compacted position of the trolley.

In a first preferred embodiment of the present invention, the service trolley comprises one left shelf and one right shelf, the left shelf is hingedly attached to the front left wall and the other shelf is hingedly attached to the front right wall; each shelf runs from the front wall to which it is attached to the corresponding rear left or right door. These shelves allow the dividing of the trolley's inner space to place several items thereon. In the folded position of the service trolley, the shelves are housed inside the front wall to which they are attached.

In addition, in a second preferred embodiment of the present invention, the service trolley further comprises one board and one pair of posts with upper ends onto which the board is detachably attached. One of the posts is detachably attached to the left side housing and the other post to the right side housing; the posts are made from post sections that assemble together and are stored in the trolley's side housings. With the additional inclusion of the board, the appearance of the service trolley of the present invention is further enhanced, as the same can be easily spotted by the public when said trolley is motionless or in motion at a sales point.

From the above, one object of the present invention is to provide a low weight collapsible service trolley, yet sturdy and with a large volumetric capacity of its interior at the same time.

Another object of the present invention is to provide a collapsible service trolley that can be easily carried around, whether in use or in its folded position.

### BRIEF DESCRIPTION OF THE DRAWINGS

The novelty aspects deemed as unique to the present invention shall be specifically set forth in the appended claims. Nevertheless, the invention—both in terms of its structure and performance thereof—along with other objects and advantages thereof, shall be better understood with the following detailed description of two preferred embodiments, when read in conjunction with the accompanying drawings, and wherein:

FIG. 1 is a left front perspective view of a collapsible service trolley built pursuant to one first embodiment of the present invention, the trolley being in its upright position.

FIG. 2 is a rear left perspective view of the collapsible service trolley shown in FIG. 1.

FIG. 3 is a rear view of the collapsible service trolley of FIG. 1.

FIG. 4 is a rear view of the collapsible service trolley of FIG. 1 with its rear doors opened.

FIG. 5 is a rear left perspective view of the collapsible service trolley of FIG. 1 with its rear doors opened.

FIGS. 6 to 13 show the sequence of movements by means of which the service trolley of FIG. 1 is folded.

FIG. 14 shows a rear left fragmented perspective view of the service trolley of FIG. 1, in its folded position.

FIG. 15 is front left perspective view of a second preferred embodiment of the service trolley of the invention.

FIG. 16 is a front right and exploded perspective view of the embodiment of the service trolley shown in FIG. 15.

### DETAILED DESCRIPTION OF THE INVENTION

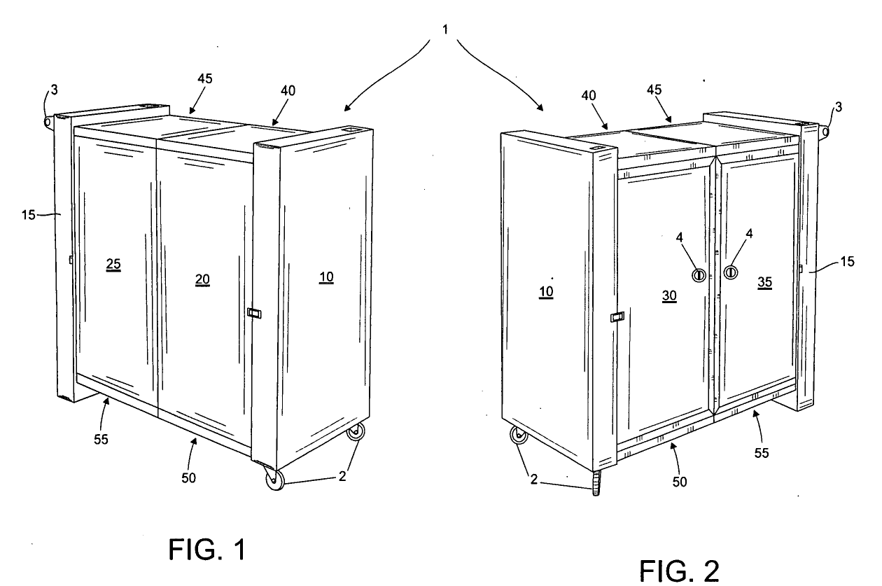

In reference to the accompanying drawings, more specifically to FIGS. 1 through 4 thereof, there are shown a collapsible service trolley 1, which is constructed according to a first preferred embodiment of the present invention for illustrative rather than limiting purposes. In the present detailed disclosure, left, right, front and rear directions of the service trolley are intended when the user is standing behind the trolley and waiting on a customer.

In the collapsible service trolley 1 of this first preferred embodiment, it can be seen that there exists one left side housing 10 in the shape of a box, that is, en the shape of a parallelepiped, which essentially shapes the left side of the service trolley 1. At the opposite side of the trolley, there is one right side housing 16 also in the shape of a box or parallelepiped. These housings 10 and 15 are hollow and have this preferred shape because in the folded position of the service trolley 1, the remaining parts thereof shall be housed inside side housings 10 and 15, as will be shown throughout the present disclosure.

At the front part of the service trolley 1, one front left wall 20 that is hingedly attached to the left side housing 10 such that the leg front wall 20 can be moved and housed within said left side housing 10 when the car 1 is folded. Similarly, one front right wall 25 can be seen that is hingedly attached to the right side housing 15 and housed inside the same when the car is folded. Graphic material can be placed on the surface of the front walls 20 and 25; also, the walls can be transparent to look inside the service trolley 1, something useful when food is carried therein such as desserts.

At the service trolley's 1 rear end one rear left door 30 can be observed that is hingedly attached to the left side housing 10 and to be housed inside the same. In the embodiment disclosed, the rear left door—when housed—remains on the front left wall 20 when the latter is also housed therein; however, in the present invention, there is no restriction on doing the opposite, that is, the front left wall 20 can remain on the rear left door 30 when housed.

As can be seen as well, there exists one rear right door 35 that is hingedly attached to the right side housing 15 and to be housed inside thereof and over said front right wall 25 when the latter is housed inside the right side housing 15. However, as in the case of the left side, there is no restriction for the front right wall 25 to remain over the rear right door 35 when housed.

Now, at the upper part of the service trolley 1 of this preferred embodiment, it comprises one upper left wall 40 hingedly attached to the left side housing 10. In the embodiment being described, said upper left wall 40 shall be housed inside the left hide housing 10 and on the rear left door 30 when the latter is housed. On the other hand, there also exists one upper right wall 45 hingedly attached to the right side housing 15 and hingedly attached to the upper left wall 40. In this embodiment, the upper right wall 45 will be housed inside the right side housing 15 and on the rear right door 35 when the latter is housed. The upper left and right walls 40 and 45 connect said left and right side housings 10 and 15 by the upper part thereof.

At the bottom of the service trolley 1, there is one bottom left wall 50 hingedly attached to the left side housing 10 and housed therein; in the embodiment being described the bottom left wall 50 will be housed on the rear left door 30 when the latter is housed as well. The trolley 1 is also provided with one bottom right wall 55 hingedly attached to the right side housing 15 and hingedly attached to the bottom left wall 50; the bottom right wall 55 is housed inside the right side housing 15 and on the rear right door 35 when the latter is also housed in the right side housing. The bottom left and right walls 40 and 45 connect said left and right side housings 10 and 15 by their bottom.

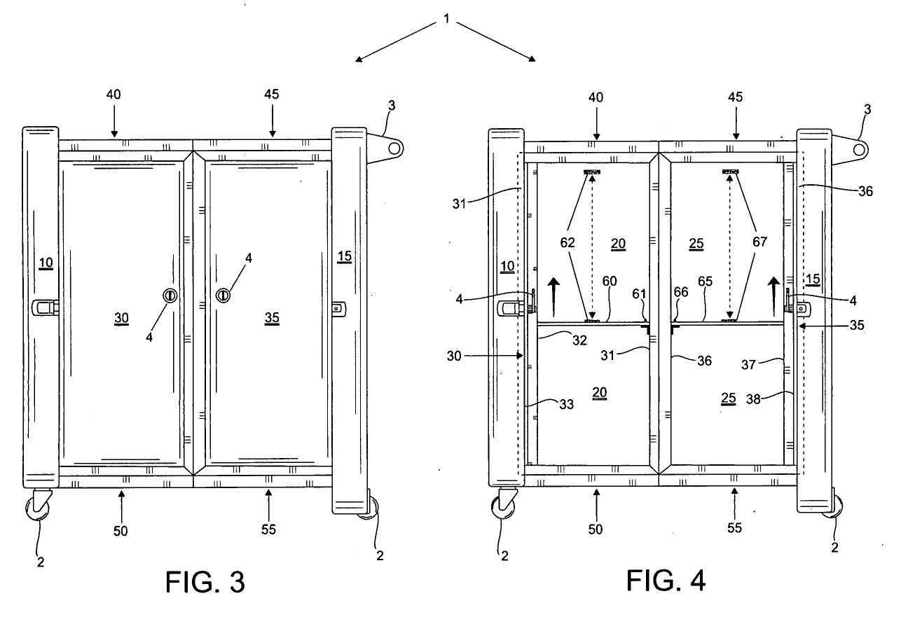

The service trolley 1 includes wheels 2 that are assembled to the bottom of the left and right side housings 10 and 15, the wheels allowing movement of the trolley on any surface. In particular, the wheels 2 are arranged in two pairs, one of these pairs of wheels 2 is assembled at the bottom of the left side housing 10 and can be rotated so that the trolley is guided towards the left or right when it is driven. Meanwhile, the other pair of wheels 2 is assembled to the bottom of thee right side housing 15 and only pivots over its horizontal axis. As can be seen particularly in FIGS. 3 and 4, the size of the left side housing 10 than that of the right side housing 15, mainly due to the assembling of the wheels on the left side housing 10 that allows the trolley to be turned; however, there is no restriction in the sense that both side housings 10 and 15 are sized the same and that the pairs of wheels pivot over one vertical axis or not.

Driving of the service trolley 1 takes place by pushing the trolley 1 by means of the driving bar 3 which is mounted as shown on the upper and lateral part of the right side housing 15, although there are no restrictions as well for the driving bar 3 to be assembled to the left side housing 10 or that a second driving bar is simultaneously included at the left side housing 10.

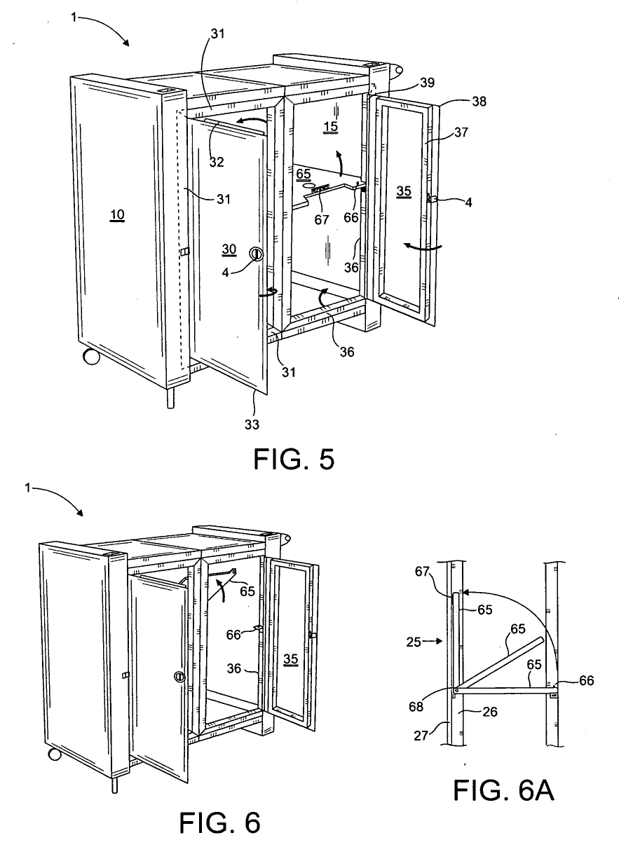

Reference is now made to FIGS. 4 and 5 that show two rear views of the service trolley, with their rear doors 30 and 35 open to show the interior of the service trolley 1. In particular, FIG. 4 shows the rear face of the front walls 20 and 15, respectively from which one left shelf 60 and one right shelf 65; the left shelf 60 is hingedly attached to the front left wall 20 and the right shelf 65 is hingedly attached to the front right wall 25. In the service trolley 1 upright position, each shelf 60 and 65 run from the front wall to which it is attached towards the corresponding rear left 30 or right 35 doors. In addition, each shelf 60 and 65 is attached to the corresponding rear door by first fixing means that, in the embodiment being disclosed, correspond to the bases or pinned brackets 61 and 66 that are mounted at the door frames 31 and 36 that are part of the corresponding rear left and right doors 30 and 35.

It is important to point out that these left and right shelves 60 and 65 are an option, but in the embodiment described, serve to split the inner space of the service trolley 1 and arrange the items being carried in the trolley. In the folded position of the service trolley 1, each left and right shelf 60 and 65 are movable and can be fixed in a vertical position to the front wall to which it is attached. For this purpose, second fixing means are used that, in the embodiment being disclosed, belong to the Velcro® co-operating portions 62 and 67 (hook and fiber fixing portions) provided both at the rear face of the front walls 20 and 25 and at the upper face of the shelves 60 and 65. In the embodiment being disclosed, the shelves 60 and 65 move upwardly so that the Velcro® portions 62 (hook and fiber fixing portions) on the left side hook between each other, and the same can happen with the Velcro® portions 67 (hook and fiber fixing portions) on the right side. In the same regard, there are no restrictions for the shelves 60 and 65 to be moved downwardly and secured over the upper wall to which they are attached if hook and fiber fixing portions (Velcro®) are provided at the bottom of the front walls and at the bottom face of the shelves 60 and 65. Furthermore, there are no restrictions regarding the use of other fixing means such as clasps, male-female couplings that allow the shelves 60 and 65 to be fixed in a vertical position to the front wall 20 or 25 to which they are attached. Each shelf 60 and 65 is preferably manufactured of a single PVC plate whose ends are bent with heat in order to form rounded edges, although they can also be made from a plate supported on a frame that is hingedly attached to the corresponding front wall 20 or 25.

Still in reference to FIGS. 4 and 5, it can be mentioned that the rear right door 35, in addition to its door frame 36, includes one inner frame 37 that provides stiffness to the rear right door 35 and one plate 38 that is attached on top of said inner frame 37. The plate 38 is hingedly mounted to the door frame 36 by means of the hinge 39 to allow opening and closing of the rear right door 35, thereby to gain access towards the interior of the service trolley 1 (see FIG. 5 in particular).

Now, in order to allow the rear right door 35 to be housed inside the right side housing 15, the door frame 36 is hingedly attached by the right side thereof to the internal surface of said right side housing 15; in other words, the right side of the door frame 36 is attached inside the right side housing 15. Accordingly, when the rear right door 35 is secured to its door frame 36, the entire door 35 moves towards the interior of the service trolley 1 so that the rear right door 35 is housed in the right side housing 15. In FIG. 4, the right side of the door frame 36 is represented by a broken line as it is hidden by the right side housing 15.

On the left side of the service trolley 1, the same structural relationship of the rear left door 30 with the side housing 10 exists on the same side; i.e., in addition to the door frame 31, the rear left door 30 is formed by the inner frame 32 and the plate attached on top of said frame to cover the same, the plate 33 is hingedly attached to door frame 31 so that the rear left door 30 can be opened and closed over its door frame 31. Meanwhile, the door frame 31 is hingedly attached by its left side to the internal surface of the left side housing 10 so that the entire rear left door 30—including its frame 31—can be housed inside the housing 10 from that same side. In FIGS. 4 and 5, the left side of the door frame 31 is represented by a broken line for clarification purposes and for showing that it is attached to the left side housing by its interior.

The rear left and right doors 30 and 35 include first locking means to block the door to its corresponding door frame 31 and 36, these means are the locks 4 that can also be seen in FIGS. 2 and 3. Likewise, padlocks can be used as the first locking means.

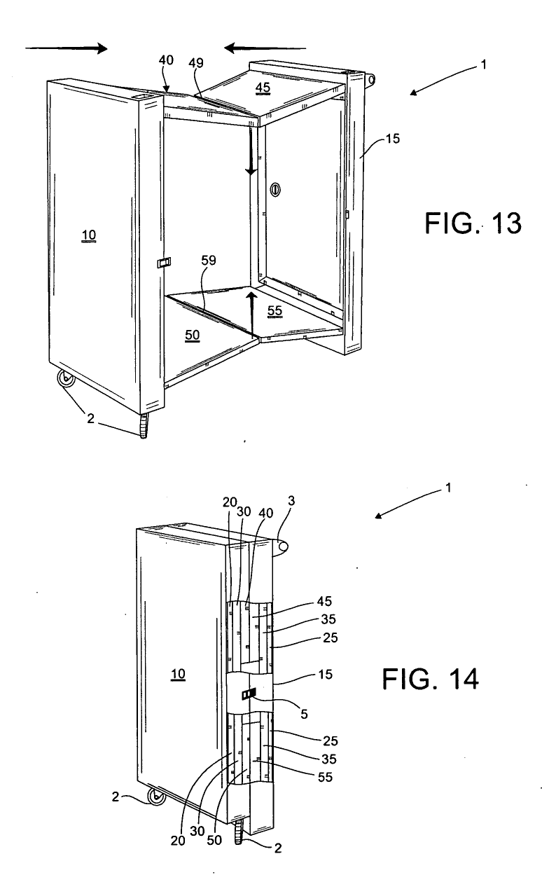

Reference is now made to FIGS. 6 through 13 to disclose the manner in which the car is being folded. In order to avoid confusion regarding the number references in such FIGS. 6 and 13, only the elements that move to allow the folding of the service trolley 1 are shown.

To start with, in FIGS. 6 and 6A the right shelf 65 of the service trolley 1 is released from the base pinned base 66 with an upwardly movement; it should not be forgotten that the pinned base 66 is mounted to the door frame 36 of the rear right door 35, the base 66 serves to fix the shelf 65 in a horizontal position when the trolley is in a upright position. With special reference to FIG. 6A, which shows how the right shelf 65 stands up to be released from the base 66 and vertically fixed on the internal face if the front right wall 25 by means of the Velcro® co-operating portions 67 (hook and fiber fixing portions). In the embodiment shown, the front right wall 25 is formed of one frame 26 and one plate 27 that is attached to and covers said frame. In order to allow the right shelf 65 to hingedly attach to the front right wall 25, one shaft 68 is mounted on the internal face of the frame 26 and received inside the right shelf 65.

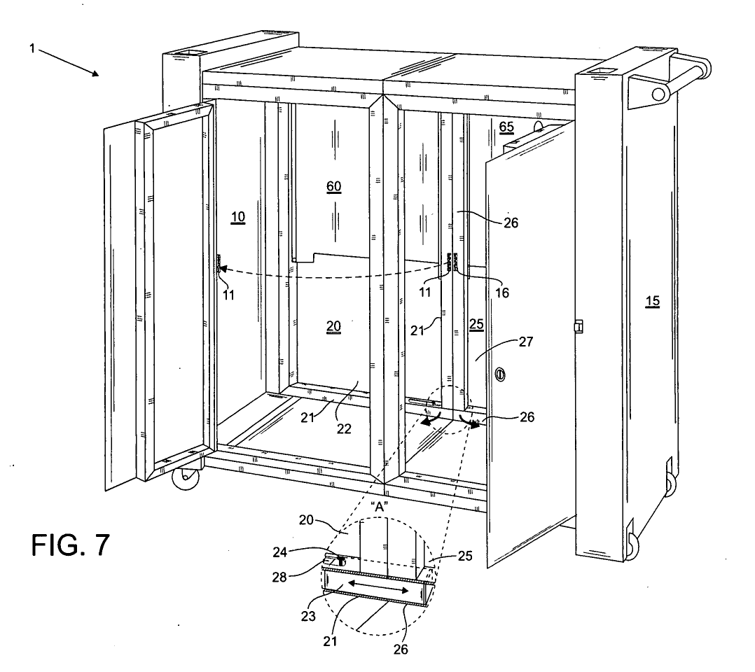

Although not shown in FIGS. 6 and 6A, it can be mentioned that on the left side of the service trolley 1, the left shelf is risen to be housed inside the front left wall, and so the service trolley reaches a position where both left and right shelves 60 and 65 are secured in a vertical position to the corresponding front left and right wall 20 and 25 as shown in FIG. 7.

From FIG. 7, it can be mentioned that while the trolley 1 is in its upright position, said front left and right walls 20 and 25 are interconnected to each other to provide structural stiffness to the front part of the service trolley 1. The front left wall 20 is formed of one frame 21 and one plate 22 attached thereon and, as mentioned, the front right wall 25 is formed of the frame 26 and the plate 27. For interconnection between both front walls 20 and 25, first connection means are used that, in the embodiment being shown, comprise one pair of sliding pins 23 that may be provided inside the frame of the front left or right wall. When laterally slid, each pin is inserted in the frame of the opposite front wall, so as to interconnect both front walls.

In FIG. 7, it can be seen that the pins 23 are provided inside the frame 21 of the front left wall 20, specifically one of these pins is provided inside the bottom side of the frame 21 and seen in detail “A” of FIG. 7, the other pin being provided in the upper side of the frame 21 of the front left wall 20 and not perceived in FIG. 7. Detail “A” shows that the pin 23, when laterally slid it is inserted inside the frame 26 of the front right wall 25. More specifically, the pin 23 consists of one hollow tubular profiles portion that runs inside and laterally within the frame 21 of the front left wall 20. The pin is driven by means of the head bolt 24 and runs alongside one channel 28 provided on the frame 21 of the front left wall 20. Other means to interconnect the front walls 20 and 25 can also be provided such external hooks or pins. Nevertheless, the hooks are the best fit for the embodiment being disclosed, as they are essentially hidden.

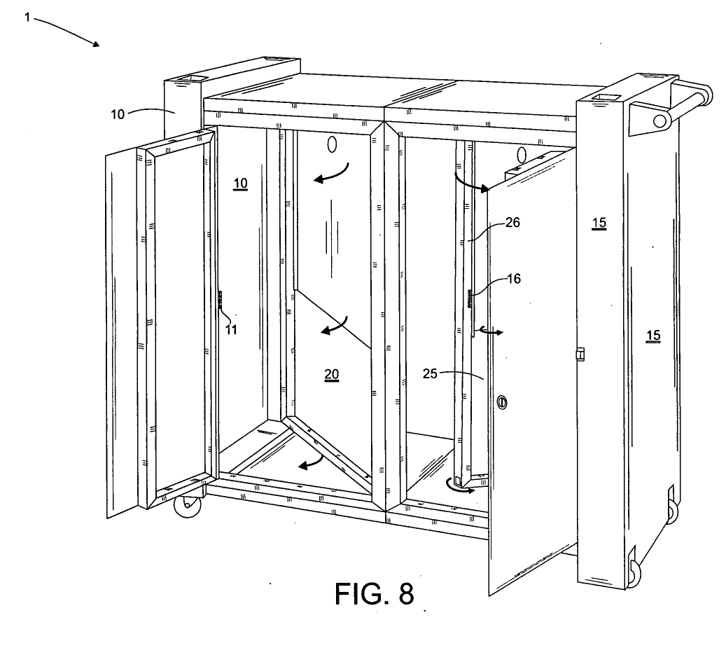

In order to house the front walls 20 and 25, the same have to be disconnected by removing the pins from the frame 26 of the front right wall, and as a result the front left and right walls 20 and 25 become disconnected and move towards the side housing 10 or 15 to which they are attached in order to be housed inside the same, as shown in FIG. 8. Furthermore, in order to allow the front left and right walls 20 and 25 to remain fixed inside the housing by their corresponding side, the frame 21 from the front left wall 20 and the left side housing 10 are provided with third fixing means as the Velcro® co-operating portions 11 (hook and fiber fixing means) that hook between each other (see FIG. 7). Similarly, in the frame 26 from the front right wall 25 and inside the right side housing 15 there are also provided Velcro® co-operating portions 16 (hook and fiber fixing means). Other means to fix the front left and right walls 20 and 25 inside their corresponding housing can also be employer, however, the Velcro® portions 11 and 16 (hook and fiber fixing means) can be easily adhered to the corresponding surface and are barely perceptible, and therefore are preferably employed for such purpose.

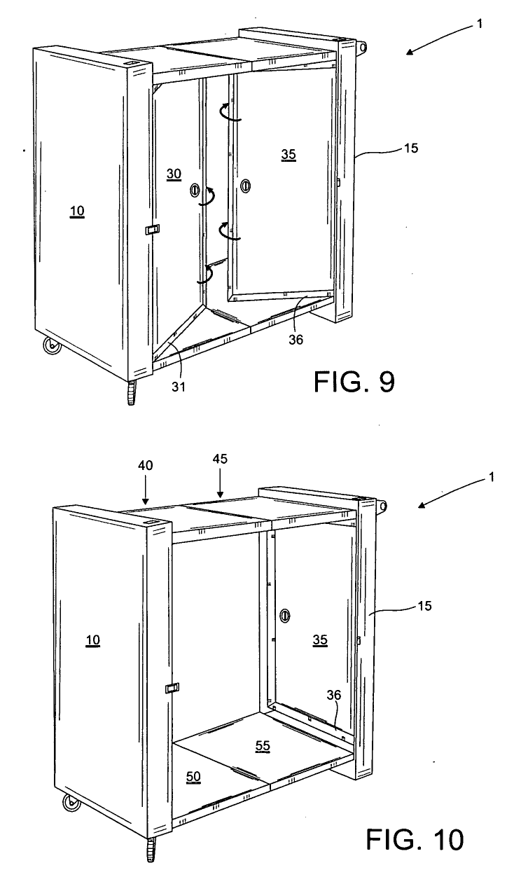

Reference is now made to FIGS. 9 and 10, in order to describe the manner in which the rear left and right doors 30 and 35 are housed inside the corresponding left and right housings 10 and 15 of the service trolley. For this purpose, both doors 30 and 35 move towards the side housing 10 and 15 to which its door frame 31 and 36 is attached. When housed, the rear doors 30 and 35 remain on the front wall of the corresponding side where these doors had already been housed into, as described before. Again, there is no restriction for the rear doors 30 and 35 to be housed inside their corresponding housing before the front walls 20 and 25.

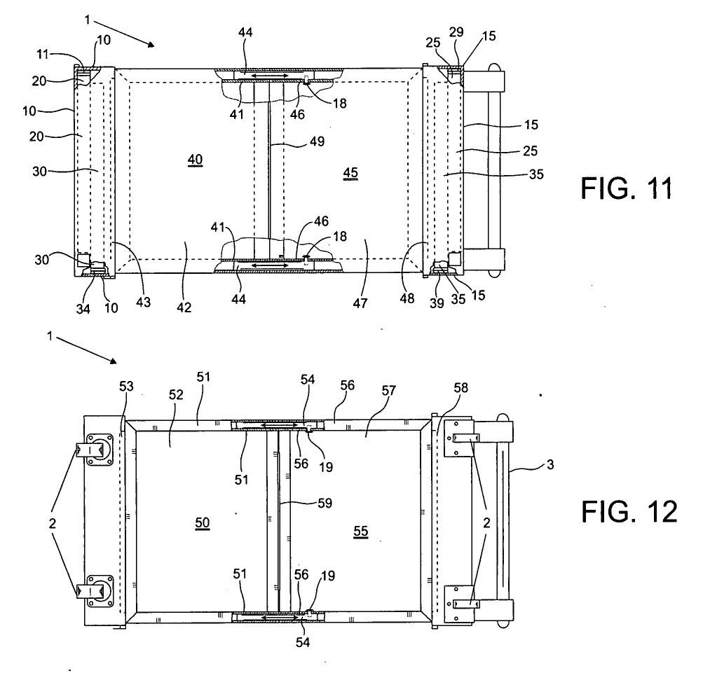

Specifically, FIG. 11 shows a top plan view of the collapsible service trolley 1 according to the position reached in FIG. 10. It is convenient to point out that the rear left door 30 is represented in broken lines in FIG. 11, said door being housed inside the left side housing 10 and on the front left wall 20 that had previously been housed. In the same manner, the rear right door 35 is shown inside the right side housing 15 and on the front right wall that had already been housed. Likewise, the hinge 34 is shown by means of which rear left door 30 is hingedly attached to the left side housing 10, as well as the hinge 12 by means of which the front left wall 20 is attached to the left housing 10. On the right side of the trolley there is shown the hinge 39 that allows the attachment of the rear right door 35 to the right side housing 15 and, finally, there is shown the hinge 29 that allows the attachment of the front right wall 25 to the interior of the right side housing 15.

Still in reference to FIG. 11, it should be mentioned that the upper left wall 40 is formed of one frame 41 on top of which one plate 42 is attached, the upper left wall 40 is hingedly attached to left side housing 10 by means of the hinge 43—shown in broken lines—as it is internally adhered to the left side housing 10 and to the left side of the frame 41. On the other hand, the upper right wall 45 is formed of one frame 46 on top of which one plate 47 is attached. The upper right wall 45 is hingedly attached to the right side housing 15 by means of the hinge 48 that is internally attached to the right side housing 15 and to the right side of the frame 46 of the upper right wall 45, which in turn is hingedly attached to the upper left wall 40 by means of the hinge 49.

Now, as mentioned before, in the service trolley 1 upright position, the upper and right walls 40 and 45 are interconnected between each other by second connection means to provide structural stiffness to the upper part of the service trolley. In the embodiment disclosed, said second connection means are one pair of pins 44 that provided inside of the front side and the upper side of the frame, whether from the upper left or right wall, each pin when laterally slid is inserted inside the frame of the opposite upper wall to interconnect said upper walls 40 and 45.

More specifically, the pins 44 are provided inside the frame 46 of the upper right wall 45, each pin 44 when laterally slid is inserted inside the frame 41 of the upper left wall 40 to connect said upper walls 40 and 45. Furthermore, the pins 44 consist of one tubular profile portion that runs internally and laterally within the frame 46 of the upper right wall 45. Each pin 44 is driven by the head bolt 18 that runs alongside the channels formed in the frame 46 of the upper right wall 45. As shown in FIG. 11, the pins 44 have a similar structure and function to that of the pins 23 shown on detail “A” of FIG. 7.

As a previous step to the housing of upper walls 40 and 45, the latter have to be disconnected by removing the pins 44 from the frame 41 of the upper left wall, with which the upper left and right walls 40 and 45 become disconnected but remain together with the help from the hinge 49.

Now, reference is made to FIG. 12 that shows a bottom plan view of the service trolley 1. From this figure, it is perceived that the bottom left and right walls 50 and 55 have a similar structural relationship to that of the upper left and right walls. More particularly, the bottom left wall 50 is formed of one frame 51 on top of which one plate 52 is attached, the upper left wall 50 is hingedly attached to the left side housing 10 by means of the hinge 53—shown in broken lines—as it is internally adhered to the left side housing 10 and to the left side of the frame 51. On the other hand, the bottom right wall 55 is formed of one frame 56 on top of which one plate 57 is attached. In addition, bottom right wall 55 is hingedly attached to the right side housing 15 by means of the hinge 58 that is shown in broken lines. The bottom right wall 55 is also hingedly attached to the bottom left wall 50 by means of the hinge 59.

Likewise, regarding the upper walls in the upright position of the service trolley 1, the bottom left and right walls 50 and 55 are interconnected between themselves by third connection means, which in the embodiment described are one pair of sliding pins 54, which are provided inside of the front side and rear side of the frame of the bottom left or right wall; when laterally slid, each pin is inserted within the frame of the opposite bottom wall so as to connect both bottom walls.

Specifically, pins 54 are provided inside of the frame 56 of the bottom right wall 55; specifically one pin 54 is provided in the front side and the other one in the rear side of said frame 56. When each pin 54 is laterally slid, it inserts itself in the frame 51 of the bottom left wall 50 in order to interconnect said bottom walls 50 and 55. More specifically, the pins 54 consist of one tubular profile portion that goes inwards and laterally inside the frame 56 of the bottom right wall 55. Each pin 54 is driven by the head bolt 19 that runs along the channels provided in the frame 56 of the bottom right wall 55.

As a previous step for housing the bottom walls 50 and 55, the inner pins 54 have to be removed from the frame 51 of the bottom left wall 50, thereby the bottom left and right walls 50 and 55 are disconnected, but they remain attached due to the hinge 59. On the other hand, the wheels 2 and the driving bar 3 previously described in FIG. 12 can be clearly seen.

Once the upper walls 40 and 45, as well as the bottom ones 50 and 55 have been disconnected when the pins 44 and 44 shown in FIGS. 11 and 12 are released, the only thing to do is to bring the left and right side housings 10 and 15 closer as shown in FIG. 13 until the housings make contact by this movement. During this action, the upper left and right walls 40 and 45 fold downwardly in their attachment zone, i.e. over the hinge 49; meanwhile, the bottom left and right walls 50 and 55 fold upwardly over their attachment zone which is the hinge 59, leaving said bottom and upper walls housed in the respective side housing, thereby achieving the trolley's “folded down” position, which is very compact as can be seen in FIG. 14. This bringing closer between the housings 10 and 15 is provided by the wheels 2 on top of which said housings move.

To prevent that the service trolley 1 lose its folded position, second locking means are provided which are included in the front and rear sides of the housings 10 and 15; in a preferred way, said second locking means are locks or padlocks 5.

In FIG. 14 that shows the folded position of the service trolley, it can be seen that the front left wall 20, the rear left door 30, the upper left wall 40 and the bottom left door 50 are housed in the left side housing 10. Meanwhile, in the right side housing 15, the front right wall 25, the rear right door 35, the upper right wall 45, and the bottom right wall 55 are housed. In the folded position shown in FIG. 14, the service trolley 1 can be tilted in order to be pulled by the driving bar 3.

In order to show the compact shape that the service trolley 1 can achieve and without being a limitation for the present invention, the service trolley 1 in its folded position has a characteristic length of 16 cm from one housing to another, whereas in its upright position, it has a length of about 76 cm.; i.e., in the folded position of the trolley, the length is reduced by about 80% versus the upright position thereof. Height and width of the trolley are about 84.5 cm. and 40 cm. respectively.

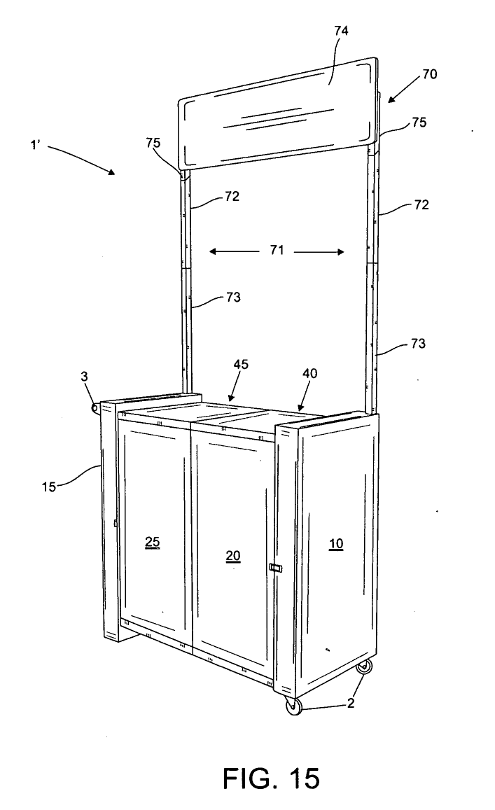

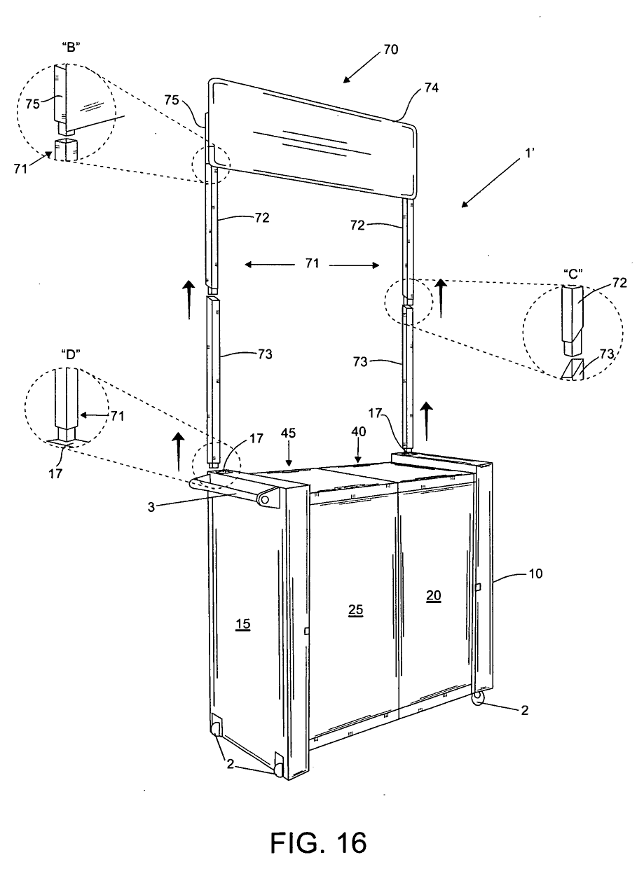

Now, reference is made to FIGS. 15 and 16 that show a second embodiment of the service trolley of this invention; this second embodiment is identified by number 1′. As readily seen, the service trolley 1′ of this second embodiment has, as additional elements, one board 70 and one pair of posts 71, to which upper end said board 70 is removably attached. Besides, one of the posts is removably attached to the left side housing 10 and the other post 70 is attached to the right side housing. To do this, the posts 71 are inserted in cavities 17 which are included at the upper part of the right and left side housings 10 and 15 (see detail “D” of FIG. 16). The board is formed by one sheet 74 attached over mounting bases 75 that are in the upper part of the sheet 74.

The posts 71 are formed by post sections that assemble between each other; particularly, they are formed of one upper section 72 and one bottom section 73. In particular, the bottom end of the upper section 72 is inserted in the upper end of the bottom section 73, see detail “C” in FIG. 16. In order to assemble the board 70 to the posts 71, the mounting bases 75 fit together to the upper end of the posts 71 (See detail “B” of FIG. 16).

One important issue is that the post sections 72 and 73 can be housed within the side housings 10 and 15, particularly by the corners thereof. Meanwhile, the board 70 can be housed in one of the housings as well, preferably inside the right side housing 15 that has a greater height regarding the left housing 10. With the inclusion of the board 70, the service trolley 1′ of this second embodiment can be easily placed at any point of sale. The remaining elements 2, 3, 20, 25, 40, and 45 of FIGS. 15 and 16 are the wheels, the driving bar, the front left and right walls and the upper left and right walls respectively, which already have been described for the first embodiment and that do not change for the second embodiment of FIGS. 15 and 16.

The service trolley of the present invention, in any of its embodiments, is highly resistant and it is preferably manufactured in polymeric materials such as PVC. More specifically, the post sections, wall frames and the doors are manufactured with extruded PVC profiles. The hinges employed are plastic hinges that adhere to the plates or to the frames with no need to bore as would be needed when metal hinges are used; however, there is no restrictions as to the use of this or other kind of hinges. On the other hand, the plates of the shelves, as well as the left and right side housings are manufactured in foamed PVC. Metal parts are limited except for the locks 4 and 5. The inner volume of the service trolley in its upright position is about 0.25 m³, without implying a size restriction, as it can be seen that with the principles of the present invention, trolleys of greater or lower capacity can be built.

As shown, the structural relationship among the elements of the collapsible service trolley allows its storage in a compact way; nevertheless, it is very resistant and can be used in countless applications as disclosed in the background of this disclosure.

Although the preferred embodiments of the present invention have been described, it should be emphasized that numerous modifications thereof are possible; e.g., the front walls can be housed over the rear doors, the type of hinges used, manufacturing materials, etc. Therefore, the present invention shall not be deemed as restricted except for the teachings of the prior art and by the scope of the appended claims.

1. A collapsible service trolley comprising:
a) one left side housing;
b) one right side housing;
c) one front left wall, which is hingedly attached to the left side housing and housed therein;
d) one front right wall hingedly attached to the right side housing and housed therein;
e) one left rear door hingedly attached to the left side housing and housed therein on top of or underneath said front left wall when the latter is also housed therein;
f) one right rear door hingedly attached to the right side housing and housed therein on top of or underneath said front right wall when the latter is also housed therein;
g) one upper left wall hingedly attached to the left side housing and housed therein on the rear door left or the front left wall when the same are housed therein;
h) one upper right wall hingedly attached to the right side housing and hingedly attached to the upper left wall; the upper right wall is housed within the right side housing on the rear right door or the front right wall when the same are housed therein; the upper left and right walls connecting said left and right side housings;
i) one bottom left wall hingedly attached to the left side housing and housed therein on the rear left door or the front left wall when the same are housed therein;
j) one bottom right wall hingedly attached to the right side housing and hingedly attached to the bottom left wall; the bottom right wall is housed in the right side housing on the rear right door or the front right wall when the same are housed therein; and
k) wheels mounted on the bottom of left and right side housings;
wherein in order to fold down the service trolley from an “upright” position, the front left wall is housed inside the left side housing and the front right wall is housed in the right side housing; the rear left door also moves inwards of the trolley to be housed inside the left side housing and the rear right door moves inwardly of the trolley to be housed in the right side housing; afterwards, the left side housing and the right side housing are brought closer to each other until they make contact, such that during this movement the upper left and right walls are folded downwardly at their attachment zone; meanwhile, the bottom left and right walls are folded upwardly at their attachment zone, and therefore said bottom and upper walls are housed in the housing on their respective side, thereby achieving the “folded” position of the trolley.

2. The collapsible service trolley of claim 1, wherein said wheels are arranged in two pairs, one of which is mounted at the bottom of the left side housing, whereas the other pair is mounted at the bottom of the right side housing.

3. The collapsible service trolley of claim 1, further comprising at least one driving bar that is mounted at upper and lateral part of the left side housing or the right side housing.

4. The collapsible service trolley of claim 1, wherein, in the trolley's upright position, said front left and right walls are interconnected to each other by first connection means to provide structural stiffness to the front part of the service trolley.

5. The collapsible service trolley of claim 4, wherein the front left and right walls are each formed of one frame and one plate attached thereon, said first connection means being one pair of sliding pins provided in the interior at the bottom side and the upper side of the frame of the front left or right wall, each pin when laterally slid is inserted inside the frame of the opposite front wall to interconnect said front walls.

6. The collapsible service trolley of claim 1, wherein in the trolley's upright position, said upper left and right walls are interconnected to each other by second connection means to provide structural stiffness to the upper part of the service trolley.

7. The collapsible service trolley of claim 6, wherein the upper left and right walls are each formed of one frame and one plate attached thereon, said second connection means being one pair of sliding pins provided in the interior at the front side and the rear side of the frame of the front left or right wall, each pin when laterally slid is inserted inside the frame of the opposite upper wall to interconnect said upper walls.

8. The collapsible service trolley of claim 1, wherein in the trolley's upright position, said bottom walls are interconnected to each other by third connection means to provide structural stiffness to the bottom part of the service trolley.

9. The collapsible service trolley of claim 8, wherein the bottom left and right walls are each formed of one frame and one plate attached thereon, said third connection means being one pair of sliding pins provided in the interior at the front side and the rear side of the frame of the bottom left or right wall, each pin when laterally slid is inserted inside the frame of the opposite bottom wall to connect said bottom walls.

10. The collapsible service trolley of claim 1, wherein the trolley additionally comprises one left shelf and one right shelf, the first shelf is hingedly attached to front left wall and the other shelf is hingedly attached to the front right wall; each shelf runs from the front wall to which it is attached to the corresponding rear left or right door and, in the service trolley's folded position, each shelf is housed inside the front wall to which it is attached.

11. The collapsible service trolley of claim 10, wherein in the trolley's upright position, each shelf is fixed to the corresponding door by first fixing means.

12. The collapsible service trolley of claim 11, wherein said first fixing means are bases with one pin that are mounted on the corresponding rear door, wherein the pin passes through the corresponding shelf.

13. The collapsible service trolley of claim 10, wherein in the trolley's folded position, each shelf is vertically positioned to the front wall to which it is attached by second fixing means.

14. The collapsible service trolley of claim 13, wherein said fixing means are hook and fiber fixing portions, provided both at the rear face of the front walls and at the upper face of the shelves.

15. The collapsible service trolley of claim 1, wherein the rear left and right doors include one door frame and first locking means to close the door to its respective door frame.

16. The collapsible service trolley of claim 15, wherein said first locking means are locks.

17. The collapsible service trolley of claim 1, wherein the left and right side housings include at their front and rear sides second locking means so that both housings are closed between each other and thus prevent the trolley from losing its folded position.

18. The collapsible service trolley of claim 17, wherein said second fixing means are padlocks or locks.

19. The collapsible service trolley of claim 1, further comprising one board and one pair of posts to which upper end said board is removably attached, one of the posts is removably attached to the left side housing and the other post to the right side housing; the posts are formed from post sections that assemble to each other and are stored in the trolley's side housings.

20. The collapsible service trolley of claim 19, wherein the board is stored in one of the side housings.
